(19) United States
(12) Patent Application Publication
(10) Pub. No.: US 2008/0175649 A1
(43) Pub. Date: Jul. 24, 2008

(54) Cylindrical apparatus with dynamic image

(76) Inventor: Carson Kar-Sein Lee, Pomona, CA (US)

Correspondence Address: BIRCH STEWART KOLASCH & BIRCH, PO BOX 747, FALLS CHURCH, VA, 22040-0747, US

(21) Appl. No.: 12/003,832

(22) Filed: Jan. 2, 2008

Related U.S. Application Data
(63) Continuation-in-part of application No. 11/477,357, filed on Jun. 30, 2006.

(51) Int. Cl. B43K 7/00

(52) U.S. Cl. 401/192

(57) ABSTRACT

A cylindrical apparatus, capable of displaying a dynamic flowing lenticular illusion, includes an inner tube, a striped pattern applied on an exterior surface of the inner tube, and a transparent outer tube coaxially mounted over the striped pattern. The outer tube has an exterior surface formed with a plurality of lenticules oriented along an axial direction of the outer tube, and an interior surface facing the striped pattern. In particular, the outer tube is rotatable with respect to the striped pattern.

This application is a Continuation-in-Part of copending application Ser. No. 11/477,357 filed on Jun. 30, 2006, the entire contents of which are hereby incorporated by reference and for which priority is claimed under 35 U.S.C. § 120.

### BACKGROUND OF INVENTION

1. Field of Invention

The present invention relates to a cylindrical apparatus, such as pen, lipstick dispenser, electric torch, a dispensing container or the like, which is capable of displaying a dynamic flowing lenticular illusion especially while being operated.

2. Related Prior Art

Writing instruments, which is a type of cylindrical apparatus, have long been utilized as a popular form of advertisement for businesses. In particular, often a corporate name or logo is printed on the surface of a writing pen. US Patent Pub. No.: 2005/0169692 shows a writing instrument for providing an informational display, comprising an elongated pen body; a lenticular display system mounted to the outer surface of the pen body. The lenticular display system includes a plurality of convex lenses, which are separated by circular grooves disposed laterally around the pen body; and at least two different images formed on paper, which is affixed or adhered to an outer surface of the pen body and tightly sandwiched between the pen body and the convex lenses. In such a fashion, an observer would be able to observe predetermined different images by relatively moving the pen body with respect to the observer's point of view, which works by a well-known principle of lenticular effect. However, it should be noted that in order to perform the lenticular effect, the convex lenses and the different images shall be stuck together, without relative movement, to fulfill a predetermined optical path.

Similarly, U.S. Pat. No. 5,494,445 discloses a display comprising a cylindrical container and a sleeve disposed about the container. The container includes a stationary rearward web having first and second superimposed striped images thereon. The sleeve includes a front web spaced in front of and substantially parallel to the rearward web. In particular, the front web includes a substantially transparent viewable portion with a set of aliquot slit-like spaces providing a series of substantially rectangular transparent windows for viewing only the first superimposed images from first angular position and for viewing only the second superimposed images from a second angular position.

From the foregoing description, both the writing pen of the US Patent Pub. No.: 2005/0169692 and the cylindrical display of U.S. Pat. No. 5,494,445 are limited to display one of the superimposed images at a time due to the principle behind the traditional lenticular effect, and the grid-like sleeve respectively.

### SUMMARY OF INVENTION

The invention discloses a cylindrical apparatus capable of displaying a dynamic flowing lenticular illusion, comprising an inner tube, a striped pattern applied on an exterior surface of the inner tube, and a transparent outer tube coaxially mounted over the striped pattern. In particular, the outer tube is rotatable with respect to the inner tube and the striped pattern. The outer tube has an exterior surface formed with a plurality of lenticules oriented along an axial direction of the outer tube and an interior surface facing the striped pattern. In such a fashion, the cylindrical apparatus can display the dynamic flowing lenticular illusion during relative rotation between the outer tube and the striped pattern. It is because each portion of the striped pattern is rotatable with respective to the outer tube, and is not limited to be viewed via a single specific lenticular lens. In stead, while rotation of the outer tube or the inner tube, almost every portion of the striped pattern which surrounds the inner tube are to be covered or scanned by each of the lenticules for being viewed, which performs the brand new dynamic flowing lenticular illusion and greatly differs from the traditional lenticular effect.

Preferably, the cylindrical apparatus includes a functional unit to perform a specific function, such as dispensing or the like, while rotation of the outer tube or the inner tube.

In one embodiment, the cylindrical apparatus constitutes a writing pen with a refill served as the functional unit so that rotation of the outer tube causes the refill to be retracted for safe keeping or extended for writing.

In another embodiment, the cylindrical apparatus constitutes a stick product, such as lip stick, lip balm, glue stick or candy stick, with a semisolid, stick-like substance served as the functional unit so that rotation of the outer tube causes the semisolid substance to be extended for application or retracted for safe keeping.

In yet another embodiment, the cylindrical apparatus constitutes an electronic device, such as light torch, with an electronic module served as the functional unit so that rotation of the outer tube causes the electronic module to be turned on for application or turned off.

In a further embodiment, the cylindrical apparatus constitutes a dispensing container with a container defining a notch to be uncovered for dispensing or covered for sealing responsive to rotation of the outer tube or the inner tube.

The present invention and the advantages thereof will become more apparent upon consideration of the following detailed description when taken in conjunction with the accompanying drawings.

### BRIEF DESCRIPTION OF DRAWINGS

FIG. 1 is an exploded view of a writing pen in accordance with a first embodiment of the invention;

FIG. 2 is a cross section of the writing pen of FIG. 1 taken along its longitudinal axis, showing a refill of the writing pen is in a retracted position;

FIG. 3 is a view similar to FIG. 2, illustrating the refill is in an extended position;

FIG. 4 is an exploded view of a stick product (lip balm) in accordance with a second embodiment of the invention;

FIG. 5 is a cross section of the stick product of FIG. 4 taken along its longitudinal axis, illustrating the balm substance is in a retracted position;

FIG. 6 is a view similar to FIG. 5, illustrating the balm substance is in an extended position while rotation of the outer tube;

FIG. 7 is an exploded view of an electronic device (light torch) in accordance with a third embodiment of the invention;

FIG. 8 is a cross section of a light torch of FIG. 7 taken along its longitudinal axis, illustrating the light torch is turned off;

FIG. 9 is a view similar to FIG. 8, illustrating the light torch is turned on while rotation of the outer tube;

FIG. 10 is an exploded view of a dispensing container in accordance with a fourth embodiment of the invention;

FIG. 11 is an assembled perspective view of the dispensing container of FIG. 10;

FIG. 12 is a cross section of the dispensing container of FIG. 11 taken along its longitudinal axis, illustrating the dispensing container is closed; and

FIG. 13 is a view similar to FIG. 12, illustrating the dispensing container is opened while rotation of the outer tube.

### DETAILED DESCRIPTION OF EMBODIMENTS

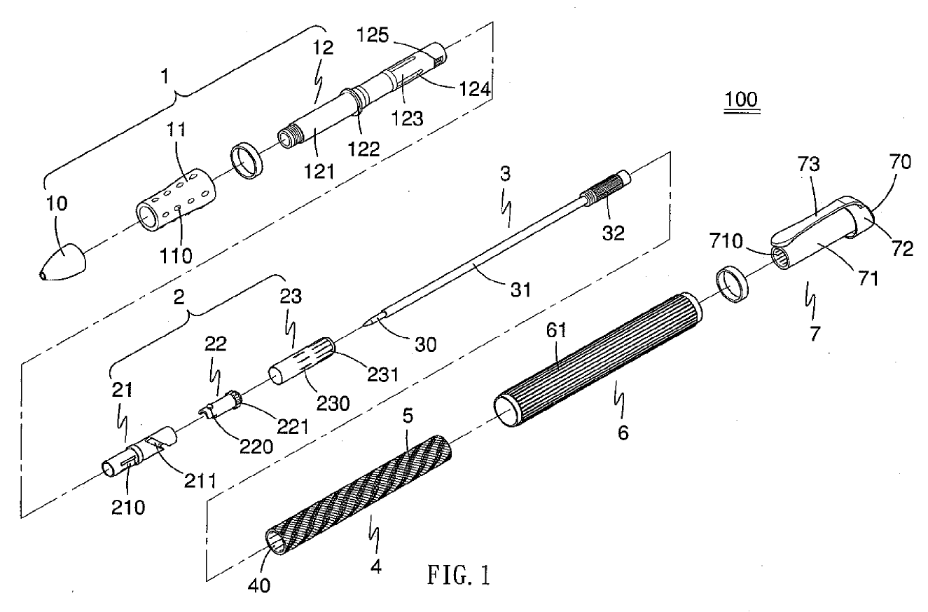

A cylindrical apparatus, namely a writing pen 100, in accordance with a first embodiment of the invention is illustrated in FIGS. 1-3 as comprising a body 1, an activating mechanism 2, a refill 3, an inner tube 4, a striped pattern 5 applied on the inner tube 4, a transparent outer tube 6 and a connecting cap 7.

As shown in FIG. 1, the body 1 includes a tapered sleeve 10, a grasping portion 11 and a tubular frame 12. The tubular frame 12 includes a first tubular section 121 in threaded engagement with the tapered sleeve 10, a second tubular section 123 extended from the first tubular section 121, and a flange section 122 formed between the first and second tubular sections 121, 123. The grasping portion 11 made of rubber is securely mounted around the first tubular section 121 and located between the tapered sleeve 10 and the second tubular section 123. A plurality of knobs 110 may be formed on the grasping portion 11 for easy grasping and handling.

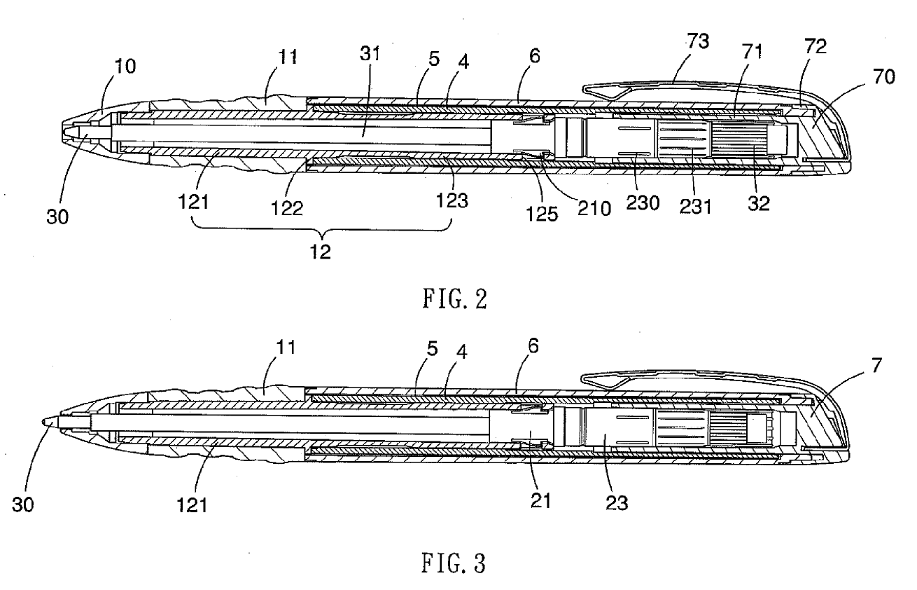

The inner tube 4 is securely mounted around the second tubular section 123 of the frame 12, as depicted in FIG. 2. A plurality of interior longitudinally extending protrusions 40 are formed on the inner wall of the inner tube 4 to be engaged with exterior longitudinally extending ribs 124 of the second tubular section 123 of the frame 12 such that the inner tube 4 is rotatable with the tubular frame 12. Placed about the inner tube 4 is the striped pattern 5, which can be fulfilled by painting, printing, or gluing paper on an outer peripheral surface of the inner tube 4.

The refill 3 disposed within the body 1 includes a pen tip 30, an ink portion 31 and a stopper 32. The ink portion 31 has one end connected with the pen tip 30 and the other end sealed by the stopper 32.

In order to drive the refill 3, the activating mechanism 2 is provided, including a linking sleeve 21, a movable sleeve 22 and a rotatable sleeve 23. The linking sleeve 21 has a snap 210 fastened in a recess 125 of the second tubular section 123 of the frame 12 in such a way that the frame 12, the inner tube 4 and the linking sleeve 21 can rotate simultaneously if any of them rotates. Further, the linking sleeve 21 defines a helical slot 211 in its peripheral to receive a knob 220 of the movable sleeve 22 so that the movable sleeve 22 is able to move with respect to the linking sleeve 21. To drive the refill 3, the stopper 32 of the refill 3 is in threaded engagement with an end of the movable sleeve 22. Further, on an outer peripheral of the movable sleeve 22 are formed with a plurality of teeth 221 to be engaged with interior longitudinally extending rails (not shown) of the rotatable sleeve 23 so that the movable sleeve 22 is confined to linearly move along the interior rails of the rotatable sleeve 23. Preferably, the rails may be formed on the inner wall by inwardly punching the rotatable sleeve 23 and therefore to leave exterior longitudinally extending grooves 231 in an outer peripheral of the rotatable sleeve 23. The rotatable sleeve 23 is coaxially disposed on the movable sleeve 22 and part of the linking sleeve 21, and is formed with exterior longitudinally extending ribs 230 on the outer peripheral thereof. In brief, the rotatable sleeve 23 is rotatable with respect to the linking sleeve 21 to enable axial displacement of the movable sleeve 22.

The outer tube 6 is coaxially mounted over the striped pattern 5, with its interior surface facing the striped pattern 5. In particular, the outer tube 6 is rotatable about the striped pattern 5 and the inner tube 4. Placed around an exterior surface of the outer tube 6 are a plurality of lenticules 61 oriented along an axial direction of the outer tube 6, as illustrated in FIG. 1. Hence, each portion of the striped pattern 5 is not limited to be scanned by a specific one of the lenticules 61 of the outer tube 6. In stead, while being rotated, each lenticule 61 is allowed to scan and enlarge almost every portion of the striped pattern 5 continuously, which greatly differs from the lenticular lens of the prior art.

In order to drive the activating mechanism 2 for the displacement of the refill 3 during rotation of the outer tube 6, there is provided the connecting cap which interconnects the outer tube 6 and the activating mechanism 2. Referring back to FIG. 1, the connecting cap 7 includes a base 70 and a central sleeve 71 extended from the base 70, and a clip 73 fastened on the base 70. The base 70 is formed with an exterior sleeve 72 concentric with the central sleeve 71 The central sleeve 71 defines a plurality of grooves 710 therein to engage with the longitudinally extending ribs 230 of the rotatable sleeve 23. In the other hand, the outer tube 6 has one end pressed fit in between the central sleeve 71 and the exterior sleeve 72 of the connecting cap 7, as depicted in FIGS. 2 and 3.

As illustrated above, since the refill 3, as a functional unit of the writing pen 100, can be driven by the activating mechanism 2 which acts responsive to rotation of the connecting cap 7 secured on the outer tube 6, rotation of the outer tube 6 causes the displacement of the refill 3. More specifically, when the outer tube 6 is rotated in a direction, the refill 3 displaces from a retracted position, as shown in FIG. 2, where the pen tip 30 of the refill 3 is hidden in the body 1, to an extended position, as shown in FIG. 3, where the pen tip 30 is exposed for writing. In contrast, when the outer tube 6 is rotated in a reverse direction, the refill 3 moves from the extended position back to the retracted position. In particular, no matter in which direction the outer tube 6 is rotated, the striped pattern 5 under the transparent outer tube 6 will be viewed as dynamic flowing lenticular illusion via the rotating lenticules 61.

From the foregoing description, the outer tube 6 is used to rotate so as to drive the refill 3 and in the meantime to perform the dynamic flowing lenticular illusion. In contrast, it is also possible for the writing pen 100 to drive the refill 3 and display the dynamic flowing lenticular illusion by rotation of the inner tube 4 and the striped pattern 5, as illustrated below.

Rotation of the grasping portion 11 causes rotation of the inner tube 4 and the striped pattern 5 since the frame 12 of the body 1 has one end joined with the grasping portion 11 and the other end interlocked with the linking sleeve 21 of the activating mechanism 2, and the inner tube 4 is mounted about the frame 12. While in use, the outer tube 6 is to be held still by fingers of one hand, and the grasping portion 1 is to be rotated by the other hand. Thus, driving the refill 3 as well as displaying the dynamic flowing lenticular illusion can also be done by rotation of the inner tube 4 and the striped pattern 6, instead of manual rotation of the outer tube 6.

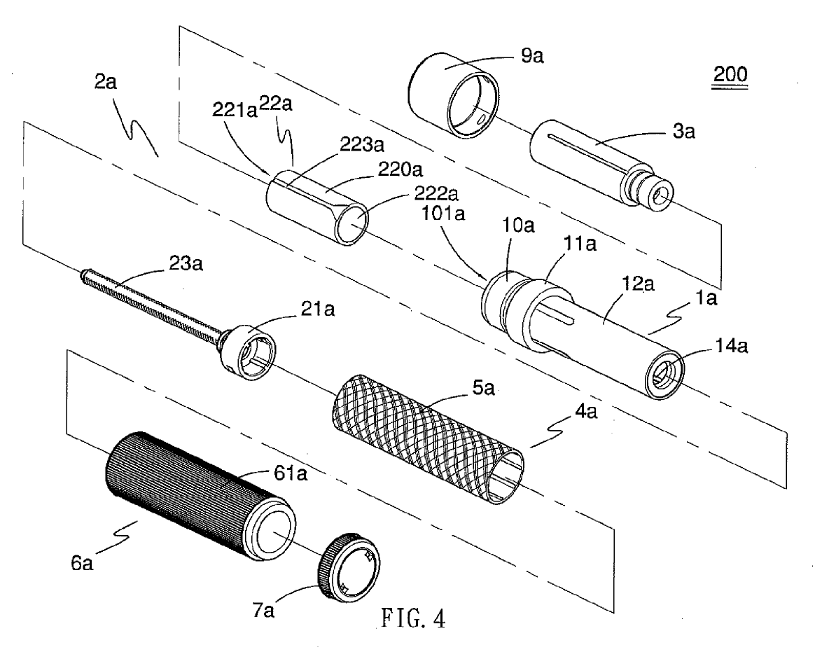

With reference to FIGS. 4-6, a cylindrical apparatus in accordance with a second embodiment of the invention is illustrated, constituting a stick product 200. Similar to the writing pen 100, the stick product 200 comprises a generally tubular and substantially cylindrical container 1a, an activating mechanism 2a, a stick substance 3a, an inner tube 4a securely disposed about the container 1a, a striped pattern 5a applied on an outer peripheral surface of the inner tube 4a, a transparent outer tube 6a, and a connecting unit 7a interconnecting the outer tube 6a and the activating mechanism 2a.

The container 1a adapted to house the stick substance 3a, such as a lip stick, lip balm, glue stick, candy stick or the like, includes a first tubular section 10a, a second tubular section 12a and a flange section 11a formed between the first and second tubular sections 10a and 12a. The first tubular section 10a has an open end 101a for dispensing the stick substance 3a. A lid 9a may be included to enclose the open end 101a of the container 1a and to protect or shield the stick substance 3a before and after application of the stick substance 3a.

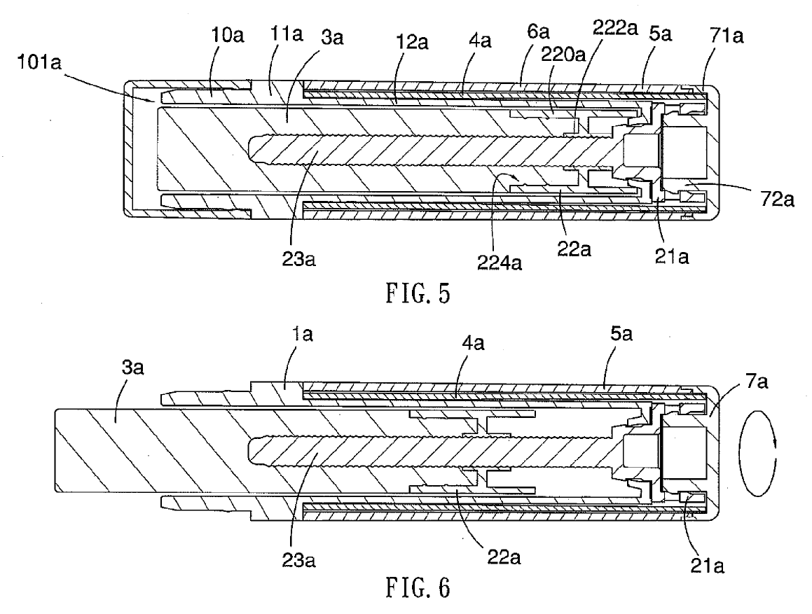

The activating mechanism 2a includes a base 21a, an externally-threaded stem 23a extended from the base 21a, and a stick holder 22a movably mounted about the stem 23a. As best seen in FIGS. 5 and 6, the stick holder 22a includes a generally tubular casing 220a that defines an open end 221a, and an internally-threaded barrel 222a that is coaxially secured within the casing 220a. If desired, an internal flange 224a may be included on the casing 220a to engage with the stick substance 3a, and external longitudinal grooves 223a may be included in the casing 223a to prevent the casing 220a from rotating relative to the container 1a during rotation of the stem 23a. In the other hand, the barrel 222a of the stick holder 22a is in threaded engagement with the stem 23a such that the stick holder 22a which carries the stick substance 3a can axially move in response to rotation of the stem 23a.

The transparent outer tube 6a is coaxially mounted over the striped pattern 5a, and is rotatable about the striped pattern 5a and the inner tube 4a. Placed around an exterior surface of the outer tube 6a are a plurality of lenticules 61a oriented along an axial direction of the outer tube 6a, as illustrated in FIG. 4. In such a fashion, each portion of the striped pattern 5a can be scanned and enlarged by most of the lenticules 61a while rotation of the outer tube 6a to provide the dynamic flowing lenticular illusion, as mentioned above.

Referring to FIG. 5, the connecting unit 7a has an outer portion 71a secured on an end of the outer tube 6a and an inner portion 72a fastened on the base 21a of the activating mechanism 2a. Thus, the stem 23a of the activating mechanism 2a can be driven by rotation of the outer tube 6a or the connecting unit 7a to move the stick holder 22a and the stick substance 3a.

It is therefore, the stick substance 3a, as a functional unit of the stick product 200, can be driven by rotating the outer tube 6a to displace from a retracted position, as shown in FIG. 5, where the stick product 3a is hidden in the container 1a, to an extended position, as shown in FIG. 6, where the stick product 3a is exposed for application when the outer tube 6a is rotated in a direction. In contrast, the stick product 3a displaces from the extended position back to the retracted position when the outer tube 6a is rotated in a reverse direction. In particular, the striped pattern 5a under the transparent outer tube 6a will be viewed as dynamic flowing lenticular illusion whatever direction the outer tube 6a may be rotated.

Similarly, it is also possible for the stick product 200 to drive the stick product 3a and display the dynamics flowing lenticular illusion by rotation of the inner tube 4a and the striped pattern 5a. Since the external grooves 223a of the casing 220a is engaged with internal ribs 14a of the container 1a to prevent rotation of the casing 220a relative to the container 1a, the stick holder 22a will spiral along the stem 23a once the exposed flange portion 11a of the container 1a is rotated. In other words, the stick substance 3a can be displaced to the extended position or the retracted position by rotating the container 1a where the inner tube 4a is mounted. Therefore, the dynamics flowing lenticular illusion can also be done by rotating the flange 11a to rotate the inner tube 4a and the striped pattern 5a while holding the outer tube 6a still.

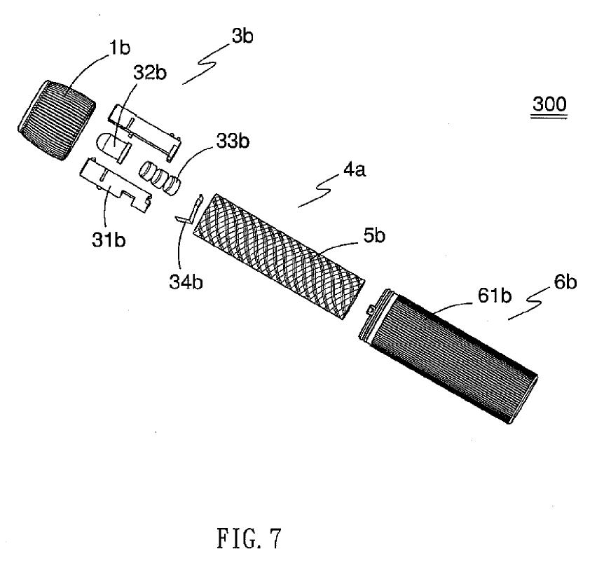

With reference to FIGS. 7-9, a cylindrical apparatus in accordance with a third embodiment of the invention is illustrated, constituting an electronic device, such as a light torch 300. The light torch 300 comprises a barrel 1b, an activating mechanism 2b, an electronic module 3b secured in the barrel 1b, an inner tube 4b, a striped pattern 5b applied on an outer peripheral surface of the inner tube 4b, and a transparent outer tube 6b having one end in threaded engagement with the barrel 1b.

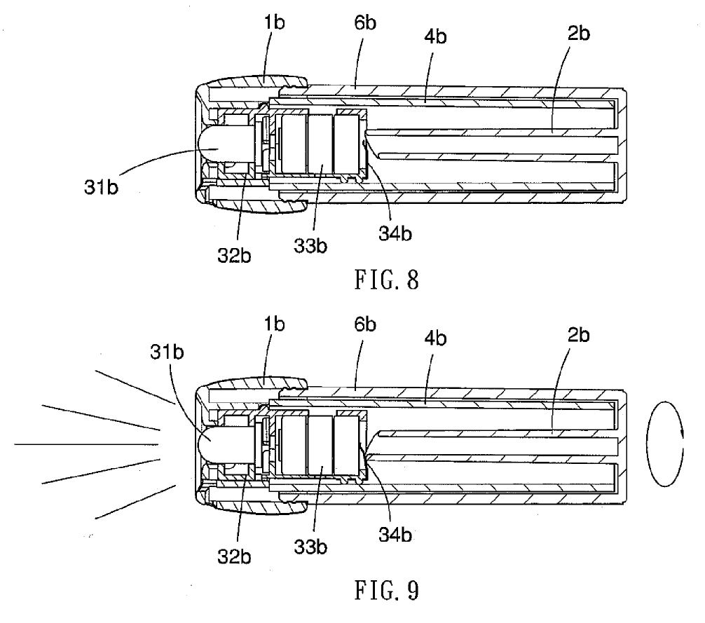

Referring to FIG. 7, the electronic module 3b mainly includes a two-shell casing 31b secured in the barrel 1b, a LED unit 32b, batteries 33b, and a spring contact 34b. The two-shell casing 31b houses the LED unit 32b, the batteries 33b, and the spring contact 34b, with an open end to expose the spring contact 34b, as shown in FIG. 8. The spring contact 34b is configured to electrically connect or disconnect the LED unit 32b and the batteries 33b so as to turn on or off the LED unit 32b of the electronic modules 3b.

Referring to FIG. 8, the outer tube 6b has an end in threaded engagement with the casing 1b so as to be spirally screwed with respect to the casing 1b. The inner tube 4b, together with the striped pattern 5b, is disposed within the transparent outer tube 6b. The outer tube 6b has an exterior surface formed with a plurality of lenticules 61b oriented along an axial direction of the outer tube 6b and an interior surface facing the striped pattern 5b. Placed within the inner tube 4b is the activating member 2b extending from or mounted to a closed end of the outer tube 6b, and the activating member 2b moves or rotates with the outer tube 6b simultaneously.

In such a fashion, when the outer tube 6b is spirally turned in a direction with respect to the barrel 1b, there are two effects happened simultaneously. One is that the outer tube 6b rotates about the static striped pattern 5b and the inner tube 4b so that the dynamic flowing lenticular illusion is performed through the lenticules 61b of the outer tube 6b, as mentioned above. The other effect is that the activating member 2b moves with the outer tube 6b to a first position for urging the spring contact 34b to contact with a bottom of the serial batteries 33b, as shown in FIG. 9, so that the LED unit 32b is powered and turned on. Contrarily, when the outer tube 6b is spirally turned in a reverse direction with respect to the barrel 1b, the dynamic flowing lenticular illusion is still performed but in a reverse way, and the activating member 2b moves back to its original position or a second position to release the spring contact 34b from contacting the batteries 33b so that the LED unit 32b is turned off. In other words, the activating member 2b is movable to the first position responsive to rotation of the outer tube 6b in the direction so as to turn on the electronic module 3b, and the second position responsive to rotation of the outer tube 6b in the reverse direction so as to turn off the electronic module 3b.

As noted above, the LED unit 32b, as a functional unit of the light torch 300, can be turned on or off by turning the outer tube 6b with respect to the barrel 1b, and in the meantime the dynamic flowing lenticular illusion is displayed.

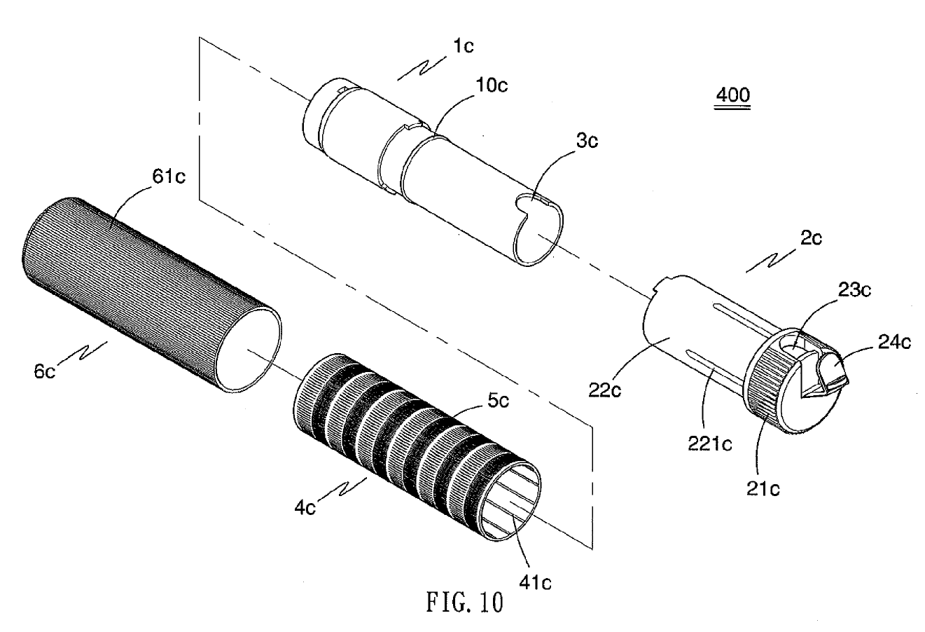

With reference to FIGS. 10-13, a cylindrical apparatus in accordance with a fourth embodiment of the invention is illustrated, constituting a dispensing container 400. The dispensing container 400 comprises a container base 1c defining a notch 3c, a driving mechanism 2c, an inner tube 4c disposed about the container base 1c, a striped pattern 5c applied on an outer peripheral surface of the inner tube 4c, and a transparent outer tube 6c.

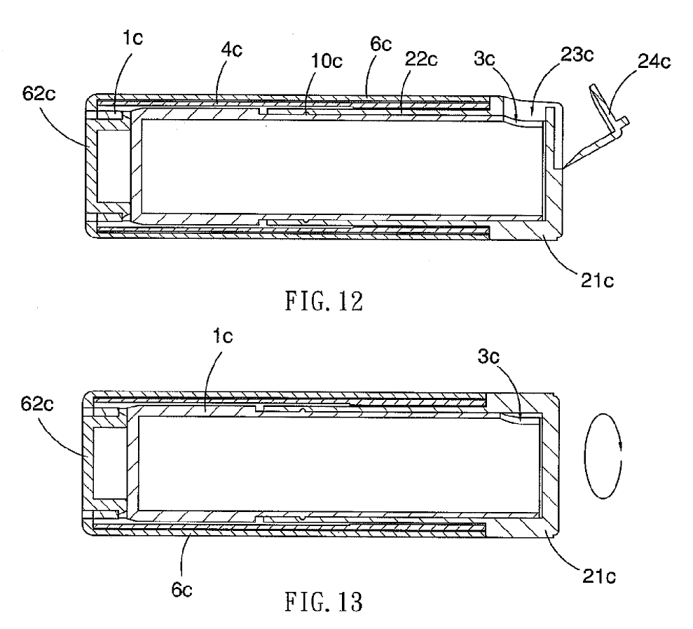

As seen in FIGS. 12 and 13, the outer tube 6c is disposed about the striped pattern 5c and the inner tube 4c and is rotatable with respect to the striped pattern 5c and the inner tube 4c. In particular, referring to FIG. 10, the outer tube 6c has an exterior surface formed with a plurality of lenticules 61c oriented along an axial direction of the outer tube 6c, and an interior surface facing the striped pattern 5c. Similar to the foregoing embodiments, the transparent outer tube 6c and the striped pattern 5c can also be rotated with respect to each other to display dynamic flowing lenticular illusion according to the present invention.

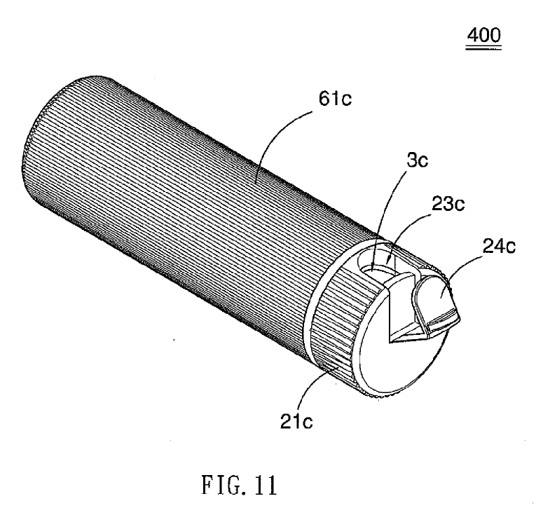

More specifically, referring to FIGS. 10 and 11, the driving mechanism 2c is formed with a neck portion 22c and a rotatable wheel end 21c. The rotatable wheel end 21c is extended from the neck portion 22c and exposed outside of the outer tube 6c to facilitate manual rotation of the neck portion 22c. Further, the wheel end 21c defines an opening 23c in a peripheral thereof and is formed with a lid 24c to cover or uncover the opening 23c. The neck portion 22c defines a plurality of longitudinal ribs 221c thereon to be engaged with longitudinal grooves 41c defined in an inner peripheral surface of the inner tube 4c in such a way that the driving mechanism 2c can be used to rotate the inner tube 4c, together with the striped pattern 5c, with respect to the outer tube 6c even though the inner tube 4c is unreachable from outside.

Referring to FIG. 10, the container base 1c is provided for storing contents (not shown), such as candies or pills, and defines a notch 3c corresponding to the opening 23c of the wheel end 21c of the driving mechanism 2c for dispensing the contents. Only when the notch 3c of the container base 10 and the opening 23c of the driving mechanism 2c are aligned with each other, as depicted in FIG. 12, the contents are obtainable. In addition, the container base 1c has one end rotatably secured to the neck portion 22c of the driving mechanism 2c. More specifically, the container base 1c is disposed within the neck portion 22c, with its flange 10 engaged with an interior annular groove (not shown) of the neck portion 22c. It is therefore that the container base 1c is kept from being detached from the neck portion 22c, but allowed to rotate with respect to the neck portion 22c. Further, the other end of the container base 1c is secured or fastened on a closed end 62c of the outer tube 6c so that the container base 1c can rotate with the outer tube 6c. In other words, the outer tube 6c can be rotated to rotate the container base 1c with respect to the inner tube 4c, the striped pattern 5c and the driving mechanism 2c.

As noted above, the container base 1c and the wheel end 21c can rotate with respect to each other by rotating either the outer tube 6c or the wheel end 21c of the driving mechanism 2c. For instance, when the lid 24c of the wheel end 21c uncovers the opening 23c, the wheel end 21c of the driving mechanism 2c may be manually rotated with respect to the outer tube 6c to enable its opening 23c being aligned with the notch 3c of the container base 1c, as shown in FIG. 12. Alternatively, the outer tube 6c may be manually rotated with respect to the wheel end 21c to rotate the container base 1c so as to enable the notch 3c to be aligned with the opening 23c of the wheel end 21C. By either way, the dispensing container 400 can be opened for dispensing as long as the opening 23c is uncovered by the lid 24. In contrast, to close the dispensing container 400, the lid 24 can be directly used to cover the opening 23c or the notch 3c and the opening 23c can be misaligned by rotating either the outer tube 6c or the wheel end 21c, as shown in FIG. 13.

On the other hand, when the outer tube 6c or the wheel end 21c are rotated, relative rotation between the outer tube 6c and the striped pattern 5c causes the dynamic flowing lenticular illusion, as mentioned in the foregoing description. That is to say, during rotation of the outer tube 6c or the wheel end 21c, the dynamic flowing lenticular illusion derived from the striped pattern 5c can be viewed via the lenticules 61c of the outer tube 6c.

The foregoing description is for purposes of illustration only and is not intended to limit the scope of the protection accorded this invention. The scope of protection is to be measured by the following claims, which should be interpreted as broadly as the inventive contribution permits.

The invention claimed is:

1. A cylindrical apparatus capable of displaying a flowing lenticular illusion, comprising:
an inner tube;
a striped pattern applied on an exterior peripheral of the inner tube; and
a transparent outer tube disposed about the striped pattern and the inner tube, being rotatable with respect to the striped pattern and the inner tube, and having an exterior surface formed with a plurality of lenticules oriented along an axial direction of the outer tube and an interior surface facing the striped pattern.

2. The cylindrical apparatus of claim 1 further comprising an activating mechanism capable of being driven by the outer tube, and a functional unit configured to be driven by the activating mechanism to displace to a first position where the functional unit is hidden when the outer tube is rotated in a direction, and a second position where the functional unit is exposed for application when the outer tube is rotated in a reverse direction.

3. The cylindrical apparatus of claim 2 further comprising a connecting unit interconnecting the outer tube and the activating mechanism to enable synchronous movement of the outer tube and the activating mechanism.

4. The cylindrical apparatus of claim 3 wherein the connecting unit includes a base and a central sleeve extended from the base; the base is joined to the outer tube so as to be movable with the outer tube; and the central sleeve is engaged with the activating mechanism so that rotation of the outer tube drives the activating mechanism.

5. The cylindrical apparatus of claim 4 constituting a writing pen, wherein the functional unit is a refill.

6. The cylindrical apparatus of claim 5 wherein the activating mechanism includes:
a linking sleeve being rotatable with the inner tube, and defining a helical slot in a peripheral thereof;
a movable sleeve having one end received within the linking sleeve with a knob engaged in the helical slot of the linking sleeve, and another end having an inner wall in threaded engagement with the refill and an outer wall formed with a plurality of teeth; and
a rotatable sleeve coaxially disposed about the linking sleeve and the movable sleeve, and having a plurality of interior longitudinally extending rails on an inner wall of the rotatable sleeve to be engaged with the teeth of the movable sleeve, and a plurality of exterior longitudinally extending ribs on an outer wall of the rotatable sleeve to be engaged with the central sleeve of the connecting unit.

7. The cylindrical apparatus of claim 4 constituting a stick product, wherein the functional unit including a substance which is formed as lipstick, lip balm, glue stick or candy stick.

8. The cylindrical apparatus of claim 1 further comprising an activating member joined to and movable with the outer tube, and an electronic module configured to be turned on by movement of the activating member when the outer tube is rotated in a direction, and to be turned off when the outer tube is rotated in a reverse direction.

9. The cylindrical apparatus of claim 8 further comprising a casing in which the electronic module is secured, wherein the outer tube is movably connected with the casing so as to enable the activating member to move to a first position to turn on the electronic module responsive to rotation of the outer tube in the direction, and a second position to turn off the electronic module responsive to rotation of the outer tube in the reverse direction.

10. The cylindrical apparatus of claim 9, wherein the outer tube has an end in threaded engagement with the casing so that the outer tube is able to be spirally twisted along the casing.

11. The cylindrical apparatus of claim 9 wherein the electronic module includes a functional unit, at least one battery provided to power the functional unit, and a spring contact configured to be urged by the activating member so as to electrically connect the battery and the functional unit when the activating member is in the first position.

12. The cylindrical apparatus of claim 1 further comprising a driving mechanism joined to the inner tube and configured to drive the inner tube, together with the striped pattern, to rotate with respect to the outer tube.

13. The cylindrical apparatus of claim 12 wherein the driving mechanism having a wheel end exposed outside of the outer tube and a neck portion extended from the wheel end and engaged with the inner tube.

14. The cylindrical apparatus of claim 13 further comprising a container base defining a notch therein, wherein the wheel end of the driving mechanism is rotatably mounted on the container base and defines an opening corresponding to the notch of the container base; and the container base and the wheel end are rotatable with respect to each other so as to enable the notch of the container base aligned or misaligned with the opening of the wheel end.

15. The cylindrical apparatus of claim 14, wherein the container base has one end rotatably secured about the neck portion of the driving mechanism to be rotatable with respect to the driving mechanism, and another end secured on the outer tube to be rotatable with the outer tube.

16. The cylindrical apparatus of claim 15 wherein the wheel end of the driving mechanism defines a lid thereon corresponding to the opening so as to cover or uncover the opening.
